(19) United States
(12) Patent Application Publication
(10) Pub. No.: US 2002/0026978 A1
(43) Pub. Date: Mar. 7, 2002

(54) Multilayer ceramic substrate and manufacturing method therefor

(75) Inventors: Hideyuki Harada, Omihachiman-shi (JP); Hirofumi Sunahara, Moriyama-shi (JP); Hiroshi Takagi, Otsu-shi (JP); Yukio Sakabe, Kyoto-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/941,180

(22) Filed: Aug. 27, 2001

(30) Foreign Application Priority Data
Sep. 7, 2000 (JP) 2000-271323

(51) Int. Cl. C03B 29/00

(52) U.S. Cl. 156/89.11

(57) ABSTRACT

A multilayer ceramic substrate three-dimensionally including functional elements is provided. The functional elements, for example, a capacitor element, an inductor element or a resistor element, are prepared using plate-like sintered plates produced by firing ceramic functional material beforehand. These functional elements are included in an unsintered composite laminate. The unsintered composite laminate is provided with green layers for the substrate, restriction layers including sintering-resistant materials, and wiring conductors, and when it is fired, the green layers for substrate are prevented from shrinking in the direction of primary faces due to the function of the restriction layers. Therefore, the unsintered composite laminate can be fired without problems while the functional elements are included, and mutual diffusion does not occur between the functional elements and the green layers for substrate, so that the characteristics of the functional elements can be maintained even after firing.

### BACKGROUND OF THE INVENTION

1. Field of the Invention

The present invention relates to a multilayer ceramic substrate produced by applying so-called non-shrinkage process in which shrinkage in the direction of the plane perpendicular to the lamination can be substantially prevented from occurring in the step of firing, and to a manufacturing method therefor. In particular, the present invention relates to a multilayer ceramic substrate having a structure in which functional elements, such as capacitor elements and inductor elements, are included in the inside thereof, and to a manufacturing method therefor.

2. Description of the Related Art

In order to increase functions and densities, and to improve performance of multilayer ceramic substrates, it is effective to install dense wirings and high precision functional elements, for example, capacitor elements and inductor elements, are included in the multilayer ceramic substrates. The aforementioned multilayer ceramic substrates including the functional elements have been produced by various methods.

For example, as described in Japanese Unexamined Patent Application Publication No. 61-288498, there is a method in which chip electronic components sintered beforehand are incorporated into a laminate composed of laminated green layers for the substrate so as to produce an unsintered composite laminate, and thereafter, the resulting unsintered composite laminate is fired so as to produce a multilayer ceramic substrate. According to this method, there are advantages that problems of variations in characteristics of the chip electronic components and cross talk of signals can be improved, and furthermore, design flexibility of the multilayer ceramic substrate can be improved.

However, since sintered chip electronic components are included in the inside of the unsintered composite laminate, the shrinkage behavior of the green layers for the substrate in the X, Y and Z directions, that is, in the direction of the primary faces and the direction of the thickness must be severely prevented during the firing. Therefore, there is a drawback in that ceramic materials usable for the green layers for the substrate are limited by a great degree, and furthermore, it encounters problems in that flatness of the resulting multilayer ceramic substrate is degraded, dimension precision is hardly improved, etc.

On the other hand, as described in Japanese Unexamined Patent Application Publication No. 11-87918, for example, there is a method in which a compact block containing a green ceramic functional material to become a functional element is embedded in a laminate composed of laminated green layers for the substrate so as to produce an unsintered composite laminate, and thereafter, by firing the resulting unsintered composite laminate, the green layers for the substrate are sintered, and, at the same time, the compact block is integrally sintered so as to produce a multilayer ceramic substrate. According to this method, there are advantages that the range of choices in ceramic materials usable for the green layers for the substrate can be extended, dimension precise is improved, and so forth.

However, during the integral firing of the aforementioned unsintered composite laminate, mutual diffusion of each component occurs between the green layers for substrate and the compact block. As a consequence, the resulting multilayer ceramic substrate encounters problems of variations in characteristics, degradation of characteristics, etc.

### SUMMARY OF THE INVENTION

Accordingly, it is an object of the present invention to provide a manufacturing method for a multilayer ceramic substrate which can solve the aforementioned problems, and a multilayer ceramic substrate produced by this manufacturing method.

In order to solve the aforementioned technical problems, to be brief, a manufacturing method for a multilayer ceramic substrate according to the present invention applies a so-called non-shrinkage process in which a plate-like sintered plate is used instead of the sintered chip electronic component used in the former of the aforementioned conventional techniques, and shrinkage in the direction of the primary faces of the green layers for the substrate can be substantially prevented from occurring during the step of firing.

That is, according to an aspect of the present invention, a manufacturing method for a multilayer ceramic substrate composed of the following steps is provided.

A plate-like sintered plate produced by firing a first ceramic functional material is prepared.

An unsintered composite laminate is produced. The unsintered composite laminate is provided with a plurality of green layers for the substrate which include second ceramic functional materials different from the first ceramic functional material and are laminated, restriction layers which are arranged so as to contact with primary faces of specified green layers among the green layers for the substrate and include sintering-resistant materials not being sintered at the sintering temperature of the second ceramic functional material, wiring conductors provided associated with the green layers for the substrate, and the aforementioned sintered plate arranged so as to extend along the primary face of a green layer for the substrate.

The resulting unsintered composite laminate is fired under temperature conditions at which the second ceramic functional materials are sintered so as to produce a multilayer ceramic substrate.

In the present invention, the sintered plate preferably has an area smaller than the area of the primary face of the green layer for the substrate.

A specified green layer among the green layers for the substrate may be provided beforehand with a cavity for storing the sintered plate. In this case, the sintered plate is stored into the cavity before production of the unsintered composite laminate.

Regarding the sintered plate, there is the case where the sintered plate itself constitutes a functional element, for example, a capacitor element and an inductor element, and the case where the sintered plate constitutes a functional element in combination with other electric elements, for example, wiring conductors provided in the multilayer ceramic substrate.

In the case where the sintered plate itself constitutes a functional element, preferably, terminal electrodes are formed on the external surfaces of the sintered plate, and the wiring conductors provided in the multilayer ceramic substrate are electrically connected to the terminal electrodes. In this case, the sintered plate may have a structure in which a plurality of layers made of the first ceramic functional material are laminated with internal conductors therebetween.

The sintered plate preferably has a thickness of about 100 μm or less.

In the step of firing the unsintered composite laminate, the firing is preferably performed at a temperature of about 1,000° C. or less.

The first ceramic functional material constituting the sintered plate preferably has a sintering temperature higher than the firing temperature in the step of firing the unsintered composite laminate.

The restriction layers provided in the unsintered composite laminate are preferably arranged so as to be located at both ends in the direction of lamination of the unsintered composite laminate. In this case, usually, the restriction layers are removed after the step of firing the unsintered composite laminate.

According to another aspect of the present invention, a multilayer ceramic substrate produced by the aforementioned manufacturing method is provided.

### BRIEF DESCRIPTION OF THE DRAWINGS

FIG. 1 is a schematic sectional view of a multilayer ceramic substrate 1 according to an embodiment of the present invention;

FIG. 2 is a diagram of an equivalent circuit imparted by the multilayer ceramic substrate 1 as shown in FIG. 1;

FIG. 3 is a schematic sectional view of an unsintered composite laminate 20 prepared in order to produce the multilayer ceramic substrate 1 as shown in FIG. 1;

FIG. 4 is an enlarged sectional view of a part where a capacitor element 7 is arranged in the unsintered composite laminate 20 as shown in FIG. 3;

FIG. 5 is a schematic sectional view of a capacitor element 27 for explaining another embodiment according to the present invention; and

FIG. 6 is an enlarged sectional view of a part of an unsintered composite laminate 35 for explaining another embodiment according to the present invention.

### DESCRIPTION OF THE PREFERRED EMBODIMENTS

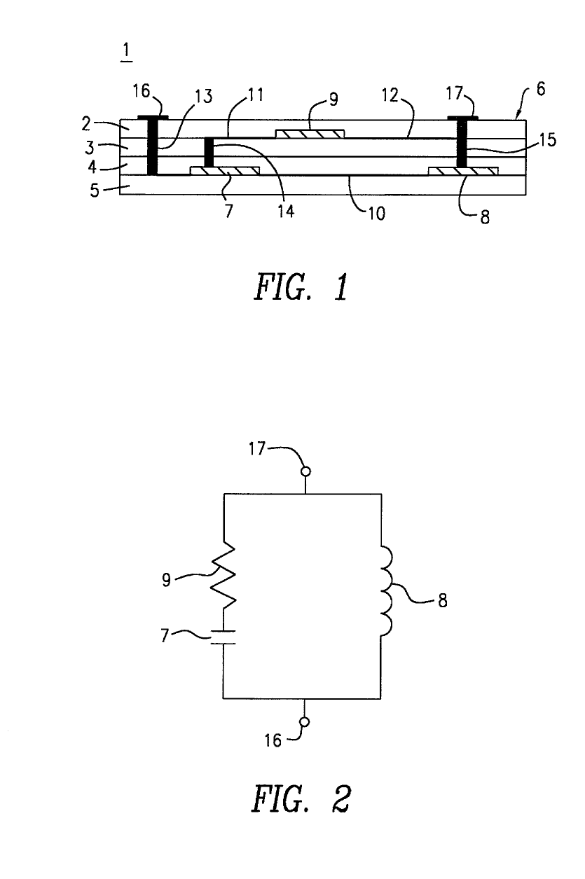

FIG. 1 is a schematic sectional view of a multilayer ceramic substrate 1 according to an embodiment of the present invention. FIG. 2 is a diagram of an equivalent circuit imparted by the multilayer ceramic substrate 1 as shown in FIG. 1.

As shown in FIG. 1, the multilayer ceramic substrate 1 is provided with a laminate 6 including laminated ceramic layers 2, 3, 4 and 5. In the inside of the laminate 6, passive components, for example, a capacitor element 7, an inductor 8 and a resistor element 9 as functional elements, are included.

Regarding the laminate 6, as wiring conductors, internal conductor films 10, 11 and 12 and via hole conductors 13, 14 and 15 are formed in the inside, and external conductor films 16 and 17 are formed on the external surfaces.

As a consequence, the multilayer ceramic substrate 1 constitutes a circuit as shown in FIG. 2. In FIG. 2, elements corresponding to the elements as shown in FIG. 1 are indicated by the same reference numerals as in FIG. 1 so as to make clear the correspondence.

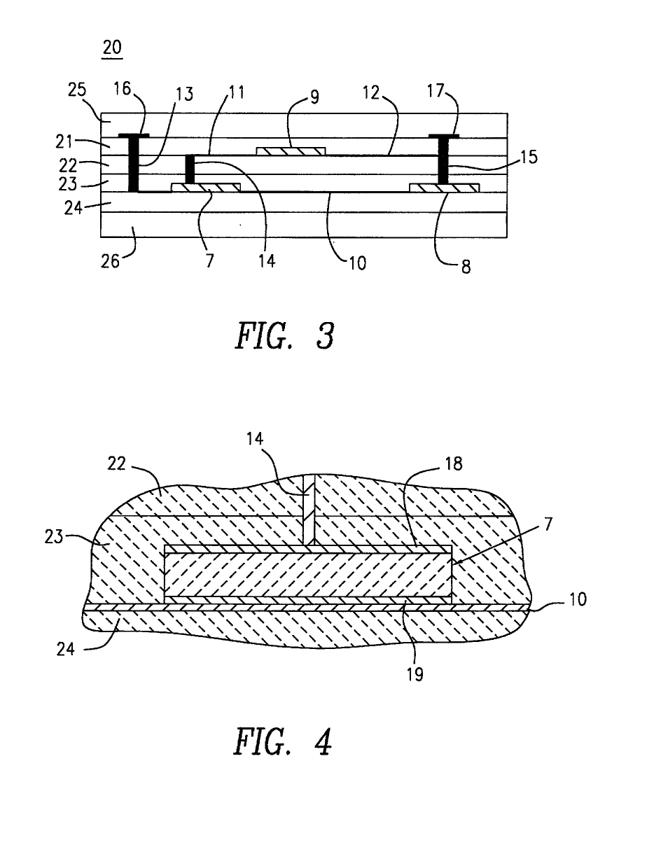

The multilayer ceramic substrate 1 having the aforementioned configuration is produced as described below. FIG. 3 is used to help explain a manufacturing method for the multilayer ceramic substrate 1 as shown in FIG. 1.

The capacitor element 7, the inductor element 8 and the resistor element 9 are prepared. Each of the capacitor element 7, the inductor element 8 and the resistor element 9 is composed of a plate-like sintered plate produced by sintering a predetermined ceramic functional material. For example, the sintered plate which constitutes the capacitor element 7 is produced by sintering a ceramic dielectric material, the sintered plate which constitutes the inductor element 8 is produced by firing a ceramic magnetic material, and the sintered plate which constitutes the resistor element 9 is produced by firing a ceramic resistor material.

The ceramic functional material which provides a sintered plate for constituting each of the capacitor element 7, the inductor element 8 and the resistor element 9 preferably has a sintering temperature higher than the firing temperature in the step of firing described below.

Terminal electrodes to be electrically connected to the wiring conductors, such as the internal conductor films 10 to 12 and the via hole conductors 13 to 15, are formed on the external surfaces of the capacitor element 7, the inductor element 8 and the resistor element 9. A magnified capacitor element 7 is shown in FIG. 4. The capacitor element 7 is provided with terminal electrodes 18 and 19 formed on respective primary faces opposing to each other so as to create a capacitance therebetween. One terminal electrode 18 is electrically connected to the via hole conductor 14, and the other terminal electrode 19 is electrically connected to the internal conductor film 10.

The sintered plate constituting each of the capacitor element 7, the inductor element 8 and the resistor element 9 preferably has the thickness of about 100 μm or less.

An unsintered composite laminate 20 as shown in FIG. 3 is produced using the aforementioned sintered capacitor element 7, inductor element 8 and resistor element 9.

The unsintered composite laminate 20 includes a ceramic functional material different from the ceramic functional material which provides the sintered plate constituting each of the aforementioned capacitor element 7, inductor element 8 and resistor element 9, for example, a ceramic insulation material, and is provided with laminated green layers for the substrate 21, 22, 23 and 24.

Restriction layers 25 and 26 are arranged so as to contact with primary faces of specified green layers among the green layers for substrate 21 to 24. The restriction layers 25 and 26 include sintering-resistant materials which do not sinter at the sintering temperature of the ceramic functional material included in the green layers for the substrate 21 to 24. In this embodiment, the restriction layers 25 and 26 are arranged so as to be located at both ends in the direction of lamination of the unsintered composite laminate 20.

The unsintered composite laminate 20 is provided with wiring conductors, for example, the aforementioned internal conductor films 10 to 12, via hole conductors 13 to 15, and external conductor films 16 and 17, which are provided associated with the green layers for the substrate 21 to 24.

Furthermore, the unsintered composite laminate 20 includes the plate-like capacitor element 7, inductor element 8 and resistor element 9, which are arranged so as to extend along the primary faces of the green layers for the substrate 21 to 24.

In order to produce the aforementioned unsintered composite laminate 20, for example, the following steps are performed.

Ceramic green sheets to become the green layers for the substrate 21 to 24 are prepared. These ceramic green sheets include, for example, a ceramic insulation material. As this ceramic insulation material, preferably, a material which can be fired at a temperature of about 1,000° C. or less is used, for example, glass or a mixture of glass and ceramic. In this case, the weight ratio of glass/ceramic is specified to be within the range of about 100/0 to 5/95. When the weight ratio of glass/ceramic is less than about 5/95, the temperature at which firing is possible becomes higher than about 1,000° C. When the temperature at which firing is possible becomes higher, the range of choices in materials used for conductive components in the wiring conductors, for example, the internal conductor films 10 to 12, the via hole conductors 13 to 15, and the external conductor films 16 and 17, are reduced.

More specifically, green sheets made by shaping a ceramic slurry, which is produced by mixing a borosilicate glass powder, an alumina powder and an organic vehicle, into sheets using a doctor blade method, etc., can be used. The ceramic green sheets made of the aforementioned materials can be fired at a relatively low temperature of about 800 to 1,000° C.

The ceramic green sheets are provided with penetration holes for forming the via hole conductors 13 to 15, if necessary. The penetration holes are filled with a conductive paste so as to form the via hole conductors 13 to 15. If necessary, the conductive paste is applied on the ceramic green sheets by screen printing, etc., so as to form the internal conductor films 10 to 12 and the external conductor films 16 and 17.

As described above, when the ceramic insulation material included in the green layers for the substrate 21 to 24 can be fired at a temperature of about 1,000° C. or less, at least one component selected from the group consisting of Ag, Ag-Pt alloys, Ag-Pd alloys, Au, Ni and Cu is used as the component included in the conductive paste for making the internal conductor films 10 to 12, the via hole conductors 13 to 15, and the external conductor films 16 and 17, for example, to provide advantages.

Then, in order to make the green layers for the substrate 21 to 24, the ceramic green sheets are laminated in a predetermined order. At this time, the capacitor element 7 and the inductor element 8 are arranged at predetermined positions on the ceramic green sheet to become the green layer for the substrate 24, and the resistor element 9 is arranged at a predetermined position on the ceramic green sheet to become the green layer for the substrate 22.

On the other hand, green sheets for restriction to become the restriction layers 25 and 26 are prepared. The restriction layers 25 and 26 include sintering-resistant materials which do not sinter at the sintering temperature of the ceramic insulation material included in the ceramic green sheets for the green layers for the substrate 21 to 24. When the ceramic insulation material included in the green layers for substrate 21 to 24 can be fired at a temperature of about 1,000° C. or less, it is essential only that the sintering-resistant material included in the restriction layer is not sintered at about 1,000° C. As the sintering-resistant material, for example, ceramic powders, such as alumina and zirconia, are used to provide advantages. The green sheets for restriction can be made by shaping a ceramic slurry, produced by mixing the aforementioned ceramic powder and an organic vehicle, into sheets using a doctor blade method, etc.

In order to form the restriction layers 25 and 26, the green sheets for restriction are laminated on the top and bottom of the laminate provided with ceramic green sheets laminated to make the green layers for the substrate 21 to 24 as described above. Accompanying this, the unsintered composite laminate 20 as shown in FIG. 3 is produced.

Thereafter, the resulting unsintered composite laminate 20 is pressed in the direction of lamination. As this press, for example, a hydraulic press with a pressure of 1,000 Kg/cm² is used. When the thickness of each of the sintered capacitor element 7, the inductor element 8 and the resistor element 9 is specified to be about 100 μm or less, undesired deformation and breaks of the wiring conductors, such as the internal conductor films 10 to 12, are made to hardly occur during the aforementioned pressing step.

Subsequently, the unsintered composite laminate 20 is fired, for example, in air at a temperature of about 900° C. By this firing, the green layers for the substrate 21 to 24 are fired so as to become ceramic layers 2 to 5 in a sintered state, respectively, as shown in FIG. 1.

On the other hand, the restriction layers 25 and 26 themselves do not substantially shrink during this firing step because these include the sintering resistant materials which are not sintered. Therefore, the restriction layers 25 and 26 exert a restriction force that prevents the green layers for the substrate 21 to 24 from shrinking in the direction of the primary faces thereof. As a consequence, when the green layers for the substrate 21 to 24 becomes the ceramic layers 2 to 5 in a sintered state, the green layers substantially shrink only in the direction of the thickness, while the shrinkage in the direction of the primary faces thereof is prevented.

Accompanying this, the dimension precision of each of the ceramic layers 2 to 5 can be improved, and therefore, even when fine and dense wirings are made using the wiring conductors, for example, the internal conductor films 10 to 12, the via hole conductors 13 to 15 and the external conductor films 16 and 17, problems of undesired deformation, breaks, etc., are made to hardly occur.

Since the green layers for the substrate 21 to 24 is prevented from shrinking in the direction of the primary faces, when the unsintered composite laminate 20 including the sintered capacitor element 7, inductor element 8 and resistor element 9 is fired, the shrinkage behavior only in the direction of the thickness of the green layers for the substrate 21 to 24 must be taken into consideration. Furthermore, since the sintered capacitor element 7, inductor element 8 and resistor element 9 have, for example, the plate-like shape of about 100 μm or less in thickness, the shrinkage behavior in the direction of the thickness need not be severely controlled.

It has been confirmed that since the capacitor element 7, inductor element 8 and resistor element 9 in a sintered state included in the unsintered composite laminate 20 did not encounter the problem of mutual diffusion during the step of firing, the characteristics of each of these elements 7 to 9 were maintained even after the firing of the unsintered composite laminate 20.

After completion of the aforementioned step of firing, the restriction layers 25 and 26 are removed. The removal of the restriction layers 25 and 26 can be easily performed because these restriction layers 25 and 26 are not sintered.

Consequently, the multilayer ceramic substrate 1 shown in FIG. 1, and provided with the sintered laminate 6 including the capacitor element 7, inductor element 8 and resistor element 9 is completed.

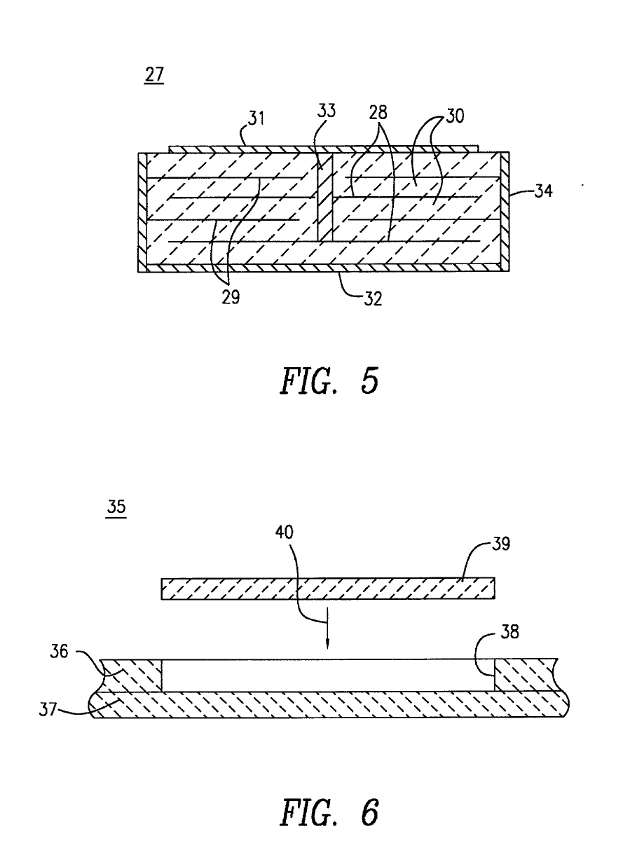

FIG. 5 is a schematic sectional view of a capacitor element 27 as a functional element to be included in an unsintered composite laminate for explaining another embodiment according to the present invention.

The capacitor element 27 is composed of a plate-like sintered plate in a similar manner to that in the aforementioned capacitor element 7. This capacitor element 27 has a structure in which a plurality of layers 30 made of ceramic dielectric material are laminated with internal electrodes 28 and 29 as internal conductors therebetween. The terminal electrodes 31 and 32 are formed on the external surfaces of the capacitor element 27.

The capacitor element 27 constitutes a monolithic ceramic capacitor in order to achieve a large capacitance. That is, each of the internal electrodes 28 and the terminal electrode 31 is facing each of the internal electrodes 29 and the terminal electrode 32, respectively, with layers 30 therebetween, and capacitance is made in each of the facing parts. The internal electrode 28 and the terminal electrode 31 are connected through a via hole conductor 33, and the internal electrode 29 and the terminal electrode 32 are connected through a terminal face conductor 34, so that the aforementioned capacitances are connected in parallel.

The capacitor element 27 can be used for producing the multilayer ceramic substrate 1 by substituting for the aforementioned capacitor element 7.

Although not shown in the drawing, regarding the inductor element, a laminate structure similar to that in the above description can be adopted, and thereby, the number of turns of the coil conductor provided in the inductor element can be increased.

FIG. 6 is an enlarged sectional view of a part of an unsintered composite laminate 35 for explaining another embodiment according to the present invention.

Green layers for the substrate 36 and 37 provided in the unsintered composite laminate 35 are shown in FIG. 6. The green layer for the substrate 36 is provided beforehand with a cavity 38. In the step of producing the unsintered composite laminate 35, a sintered plate 39 constituting a functional element is stored into the cavity 38 as shown by an arrow 40.

In this embodiment as well, a thinner sintered plate 39 is preferable. The thickness of the sintered plate 39 depends on the thickness of the green layer for the substrate 36 in which cavity 38 is provided, and typically, it is specified to be equivalent to or less than the thickness of the green layer for the substrate 36. In consideration of the shrinkage in the direction of the thickness of the green layer for the substrate 36 due to firing, the thickness of the sintered plate may be specified to be nearly equivalent to the thickness after the firing.

The present invention has been described above using embodiments with reference to the drawings, although other various modifications are possible within the scope of the present invention.

For example, a circuit design adopted in the multilayer ceramic substrate 1 as shown in FIG. 1 imparted an equivalent circuit as shown in FIG. 2. The aforementioned circuit design is only one typical example for understanding ease of the present invention. In addition to this, the present invention can also be applied to multilayer ceramic substrates including various circuit designs.

As shown in FIG. 3, the restriction layers 25 and 26 were arranged so as to be located at both ends in the direction of lamination of the unsintered composite laminate 20. However, instead of or in addition to the restriction layers 25 and 26, restriction layers may be arranged between the green layers for the substrate 21 to 24. During the step of firing, a part of the glass component, etc., contained in the green layers for the substrate 21 to 24 penetrates into the aforementioned restriction layers arranged between the green layers for the substrate 21 to 24, and thereby, a powder made of sintering-resistant material contained therein is fixed so as to solidify the restriction layers. The resulting restriction layers are not removed after the step of firing, and are present in the laminate provided in the multilayer ceramic substrate to become a product.

In the embodiments shown in the drawings, a sintered plate constituted the functional element, for example, the capacitor element 7 or 27, the inductor element 8 or the resistor element 9, although the sintered plate may combine with other electric elements provided in the multilayer ceramic substrate to constitute a functional element which imparts a specified electric function.

Furthermore, the sintered plate may have substantially the same area with the area of the primary face of the green layer for the substrate provided in the unsintered composite laminate which includes the sintered plate.

According to the present invention, the unsintered composite laminate to be fired for producing the multilayer ceramic substrate is provided with laminated green layers for the substrate, restriction layers which are arranged so as to contact with primary faces of specified green layers among the green layers for the substrate and include sintering-resistant materials not being sintered at the sintering temperature of the ceramic functional material included in the green layers for the substrate, wiring conductors provided associated with the green layers for the substrate, and the platelike sintered plate which is produced by firing a ceramic functional material different from the ceramic functional material included in the green layer for the substrate and is arranged so as to extend along the primary face of the green layer for the substrate. Therefore, the following effects can be exhibited.

During the step of firing the unsintered composite laminate, the restriction layers themselves do not substantially shrink and exert restriction force that prevents the green layers for the substrate from shrinking in the direction of the primary faces thereof. Accordingly, the green layers for the substrate are fired while the shrinkage in the direction of the primary faces thereof is prevented. As a consequence, the dimension precision of the resulting multilayer ceramic substrate is improved, and undesired deformation, breaks, etc., of the wiring conductors are made to hardly occur, so that it becomes possible to plan to increase densities of wirings, increase functions, and improve performance of the multilayer ceramic substrates.

The green layers for the substrate shrink substantially only in the direction of the thickness due to the aforementioned function of preventing shrinkage by the restriction layers. Therefore, when the sintered plate is included in the unsintered composite laminate, the shrinkage behavior only in the direction of the thickness must be taken into consideration. Furthermore, since the sintered plate has the platelike shape of reduced thickness, firing of the unsintered composite laminate including the sintered plate can be performed without problems.

Since the sintered plates are in the state after sintering, mutual diffusion does not occur between the components contained in the green layers for the substrate and the components contained in the sintered plates during the step of firing the unsintered composite laminate.

As a consequence, the sintered plates can be used to provide advantages in order to make functional elements, such as passive components included in the multilayer ceramic substrate.

When the terminal electrodes are formed on the external surfaces of the sintered plates and the wiring conductors are electrically connected to the terminal electrodes, the characteristics of the functional elements, for example, capacitor elements, inductor elements and resistor elements, which are composed of the sintered plates before being stored into the unsintered composite laminate, can be maintained after firing of the unsintered composite laminate. Therefore, a multilayer ceramic substrate exhibiting designed characteristics can be produced with ease.

When the ceramic functional material constituting the sintered plate has a sintering temperature higher than the firing temperature in the step of firing the unsintered composite laminate, the characteristics of the functional element imparted by the sintered plate can be maintained with a higher degree of reliability.

In the case where the sintered plate constitutes the functional element, the resulting functional element can be fully embedded in the inside of the multilayer ceramic substrate. Consequently, a multilayer ceramic substrate having superior environmental resistance, for example, moisture resistance, can be produced.

In the case where the sintered plates constitute the functional elements, the resulting functional elements can be three-dimensionally arranged in the inside of the multilayer ceramic substrate. Consequently, the flexibility in the circuit design can be improved, and problems of cross talk of signals, etc., can be avoided to provide advantages.

In the case where the sintered plate has a structure in which a plurality of layers made of ceramic functional material are laminated with internal conductors therebetween, the performance of the functional element composed of the sintered plate can be improved.

When the thickness of the sintered plate is specified to be about 100 μm or less, undesired deformation and breaks of the wiring conductor can be reliably prevented in the stage in which the unsintered composite laminate has been produced or it has been fired.

Among the green layers the for substrate, a specified green layer is provided with a cavity. When the sintered plate is stored in the cavity, the effect of the thickness of the sintered plate on the unsintered composite laminate can be reduced.

In the step of firing the unsintered composite laminate, when a temperature of about 1,000° C. or less is applied, for example, the range of choices in conductive components used in the wiring conductors can be increased.

What is claimed is:

1. A manufacturing method for a multilayer ceramic substrate, comprising
providing an unsintered composite laminate comprising a sintered plate of fired first ceramic functional material, a plurality of green layers for the substrate which comprise a second ceramic functional material which is different from said first ceramic functional material, at least one restriction layer are arranged so as to contact a primary face of at least one of said green layers for the substrate and which comprises a sintering-resistant material which does not sinter at the sintering temperature of said second ceramic functional material, and at least one wiring conductor associated with a green layer for the substrate, wherein said sintered plate of fired first ceramic functional material; and is arranged so as to extend along a primary face of a green layer for substrate
firing said unsintered composite laminate at a temperature at which said second ceramic functional material is sintered.

2. A manufacturing method for a multilayer ceramic substrate according to claim 1, wherein in substantially parallel planes which are substantially perpendicular to the lamination direction of said unsintered composite laminate, said sintered plate has an area smaller than the area of the primary face of the green layer for the substrate on which it is arranged.

3. A manufacturing method for a multilayer ceramic substrate according to claim 2, wherein a green layer for the substrate has a cavity, and the sintered plate is disposed in said cavity.

4. A manufacturing method for a multilayer ceramic substrate according to claim 3, wherein the sintered plate has a thickness which is less than the thickness of said cavity.

5. A manufacturing method for a multilayer ceramic substrate according to claim 1, wherein an external surface of said sintered plate has a terminal electrode thereon, and said wiring conductor is in electrical connect with said terminal electrode.

6. A manufacturing method for a multilayer ceramic substrate according to claim 5, wherein said sintered plate is a capacitor element, an inductor element or a resistor element.

7. A manufacturing method for a multilayer ceramic substrate according to claim 5, wherein said sintered plate comprises a laminate of a plurality of layers comprising said first ceramic functional material and has an internal conductor between a pair of adjacent layers thereof.

8. A manufacturing method for a multilayer ceramic substrate according to claim 1, wherein said sintered plate has a thickness of about 100 μm or less.

9. A manufacturing method for a multilayer ceramic substrate according to claim 1, wherein said unsintered composite laminate is fired at a temperature of about 1,000° C. or less.

10. A manufacturing method for a multilayer ceramic substrate according to claim 1, wherein said first ceramic functional material has a sintering temperature higher than the firing temperature employed in firing said unsintered composite laminate.

11. A manufacturing method for a multilayer ceramic substrate according to claim 1, wherein two said restriction layers are present in said unsintered composite laminate and are arranged so as to be located at both ends in the direction of lamination of said unsintered composite laminate.

12. A manufacturing method for a multilayer ceramic substrate according to claim 11, further comprising a step of removing said restriction layers after the firing of said unsintered composite laminate.

13. A manufacturing method for a multilayer ceramic substrate according to claim 12, wherein said sintered plate has a thickness of about 100 μm or less, said unsintered composite laminate is fired at a temperature of about 1,000° C. or less, and wherein said first ceramic functional material has a sintering temperature higher than the firing temperature employed in firing said unsintered composite laminate.

14. A manufacturing method for a multilayer ceramic substrate according to claim 1, wherein the green layers for the substrate comprise glass.

15. A manufacturing method for a multilayer ceramic substrate according to claim 13, wherein the green layers for the substrate comprise a combination of ceramic insulation material and glass in which the glass is at least about 5 weight percent of the combination.

16. A manufacturing method for a multilayer ceramic substrate according to claim 1, farther comprising producing said unsintered composite laminate.

17. A manufacturing method for a multilayer ceramic substrate according to claim 15, further comprising producing said sintered plate of fired first ceramic functional material.

18. A manufacturing method for a multilayer ceramic substrate according to claim 1, further comprising producing said sintered plate of fired first ceramic functional material.

19. A manufacturing method for a multilayer ceramic substrate according to claim 1, wherein said unsintered composite laminate has a plurality of said sintered plates each of which is arranged so as to extend along a primary face of a green layer for substrate and each of which is individually selected from the group consisting of a capacitor element, an inductor element and a resistor element.

20. A multilayer ceramic substrate produced by a manufacturing method according to claim 1.
